(19) United States
(12) Patent Application Publication
(10) Pub. No.: US 2014/0257957 A1
(43) Pub. Date: Sep. 11, 2014

(54) ELECTRONIC VERIFICATION DEVICE

(71) Applicants: Michael Archuleta, Austin, TX (US); Michael Archuleta, II, Austin, TX (US); Austin Archuleta, Austin, TX (US)

(72) Inventors: Michael Archuleta, Austin, TX (US); Michael Archuleta, II, Austin, TX (US); Austin Archuleta, Austin, TX (US)

(21) Appl. No.: 13/787,862

(22) Filed: Mar. 7, 2013

(51) Int. Cl. G06Q 30/02

(52) U.S. Cl. CPC G06Q 30/0225
USPC 705/14.26; 705/14.27

(57) ABSTRACT

A system and method is provided for verifying the location of a user when operating a program that tracks when a user is present at one or more locations. The system uses a display unit that displays a predictable pseudo random string that changes periodically. To verify that a user is at a particular location, the user enters the currently displayed pseudo random string in a web site. Based on the string entered, a server can verify the location of the user.

### FIELD OF THE INVENTION

This disclosure relates to location-based services. In particular, this disclosure is drawn to a system for providing location based verification.

### BACKGROUND OF THE INVENTION

It is common for businesses, groups, organizations, clubs, etc., to use social media as a form of promotion, and to communicate with people. Some businesses encourage customers to “check in” to their business by providing a mobile application or web site that allows users to check themselves in. Sometimes businesses operate a rewards program, which rewards customers who frequent their business. For example, a business might reward a loyal customer with a promotional item or discount after a certain number of visits. In one example, business use punch cards or stamp cards to track when a customer visits the business. In another example, the business will provide a mobile app or QR code, which directs the customer to a web site where they can “check in.”

All of the approaches described above have disadvantages. For example, the punch cards and stamp cards require the distribution of physical cards, and require someone at the business to punch or stamp the cards. The check-in systems rely on the honor system, since a customer does not have to be physically located in the business to “check in.” The check-in systems requiring a mobile application have the disadvantage that users don't want to have to install a mobile application for every business that they use. Even if a check-in system uses GPS data or Wifi data to try to verify that a customer is actually at the business, the customer can still check-in from outside the business, or even down the street from the business.

### SUMMARY OF THE INVENTION

A method is provided for location verification including providing an electronic device having a display and a processor, displaying a pseudo random string on the electronic device, wherein the pseudo random string changes periodically, receiving a message from a user at a first time period, the message including a string value, calculating a pseudo random string that should have been displayed on the electronic device around the first time period, comparing the string value included in the message from the user with the calculated pseudo random string, and verifying the location of the user based on the comparison of the string value and the calculated pseudo random string.

Another embodiment provides a location based verification system including an electronic device having a display and a processor, the processor including program code for displaying a sequence of pseudo random strings on the display, a remote server having program code for calculating a pseudo random string that should be displayed on the electronic device at any particular time, and program code for comparing a string value received from a user at a first time period with a calculated pseudo random string, wherein the calculated pseudo random string is calculated based on the first time period.

Another embodiment provides a method of managing a customer rewards program including providing an electronic device having a display at a first location, displaying a pseudo random string on the electronic device, wherein the pseudo random string changes periodically, when a customer is in the proximity of the first location, receiving one or more messages from the customer, wherein the messages are sent by the customer using a mobile device, and wherein the message(s) include a customer identifier and a string value entered by the customer, comparing the received string value entered by the customer with a calculation of what value the display should have been displaying at a time near when the message containing the string value was sent, verifying the location of the customer based on the comparison of the received string value and the calculated value, and awarding credits to the customer's rewards account if the customer's location was verified.

Other features and advantages of the present disclosure will be apparent from the accompanying drawings and from the detailed description that follows below.

### BRIEF DESCRIPTION OF THE DRAWINGS

The present disclosure is illustrated by way of example and not limitation in the figures of the accompanying drawings, in which like references indicate similar elements and in which:

FIG. 1 is a diagram of a device used in conjunction with a rewards program to verify the location of a user.

FIG. 2 is a block diagram of a location verification system.

FIG. 3 is a flowchart illustrating the operation of the verification system shown in FIG. 2.

FIG. 4 is a block diagram illustrating one example of the display unit shown in FIG. 1.

FIG. 5 is a block diagram showing multiple display units using a master/follower arrangement.

FIG. 6 is a flow chart illustrating one example of display unit clock drift correction.

FIG. 7 is a block diagram of an example of a display unit having a transmitter for transmitting a pseudo random string.

### DETAILED DESCRIPTION OF THE PREFERRED EMBODIMENT

Generally, the present disclosure relates to techniques for businesses, groups, charities, etc., to easily verify the location of a customer/user when operating a program that tracks when a user is present at one or more locations. For example, a merchant can operate a rewards program that rewards loyal customers that frequently visit the merchant's business. For example, a sandwich shop might offer its customers a free sandwich after X number of visits to the business. For the reasons outlined above, it can be difficult for a business owner to verify that a customer really was present at the business when the customer claimed to be.

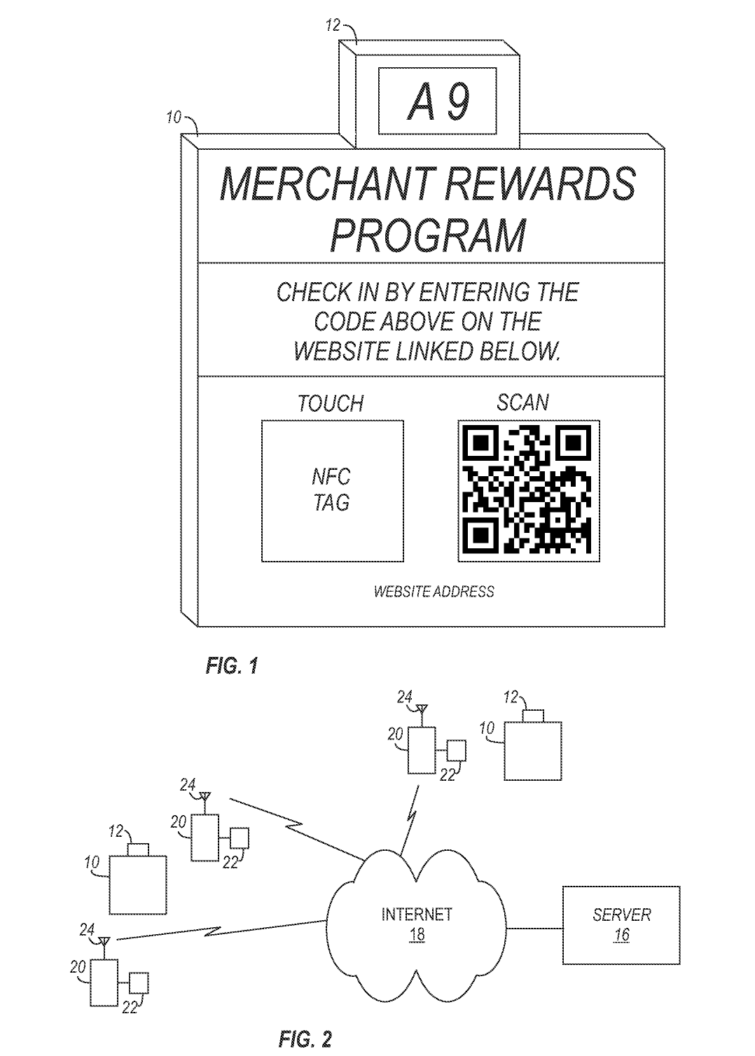

An example of a verification system will be described in the context of a rewards program, where a merchant tracks customers' visits to a business, and the customers are rewarded based on the frequency of the customers' visits. It shall be understood that the verification system can be used for other purposes and with numerous other types of programs. FIG. 1 is a diagram of a device that can be used in conjunction with a rewards program (or similar program) to verify the location of a user that checks in with the system.

FIG. 1 shows a sign 10 that may include information relating to the rewards program, such as instructions for checking in, etc. In the example of FIG. 1, the sign identifies the reward program, and provides customers with instructions for checking in while visiting the business. If desired, the sign can be related to other programs and marketing campaigns. For example, commonly owned U.S. patent application Ser. No. 13/633,621, entitled “SYSTEM AND METHOD FOR DIRECTING USERS TO WEB CONTENT,” which is expressly incorporated by reference herein, discloses a system using signs having URL information and machine readable medium to direct users to web content. The concepts disclosed in the referenced application can be used in conjunction with the display unit described below.

FIG. 1 also shows a display unit 12 that displays a pseudo random string that changes periodically. The display unit 12 can be a standalone device, integrated with a sign, integrated with a cash register or other device, overlayed on a computer monitor or TV screen, etc. In the example illustrated in FIG. 1, the pseudo random string is a two digit alphanumeric string. In other examples, the display could display information comprised of numbers, letters, shapes, colors, bar codes, etc., or any combination thereof. The length of the pseudo random string can be any desired length, only limited by hardware and software capabilities. The sequence of strings could also follow a pattern that is not thought to be random. For example, the string could simply be an increment from the previous string (e.g., 10, 20, 30, etc.). The verification process would still work, it would just be easier to circumvent. In another example, the strings could be truly random, or at least unknown to the server. In this example, the server could assume correct and incorrect entries based on a sampling of at least several entries. For example, during a given minute, if the server received 30 messages containing the string “A9” and 1 message containing the string “C4”, the server can assume that A9 is was the displayed string.

As shown in the example of FIG. 1, the sign instructs users to go to a particular website address (by typing a URL, scanning a barcode, tapping an NFC tag, etc.). When “checking-in”, the user, is instructed to enter the string displayed on the sign, in this example, “A9”. The user also provides an identifier, such as a username, email address, phone number, etc., to the system will know who has checked in. In another example of entering the pseudo random string, the web site provides a multiple choice option to the user, making things simpler for the user. In this example, the web page is changed dynamically, since the pseudo random string changes periodically.

The pseudo random string appears random, but is predictable. Therefore, by knowing when a user views the string, it can be predicted what the display should have read, and therefore provides a way to verify that the customer was in fact within viewing range of the display unit 12 when the user entered the string. If a user checks in and enters a wrong string, then it can be assumed that the user was not really within viewing range of the display 12. This arrangement presents several advantages. For example, the verification system does not require a data connection at the location of the display unit. The system also does not require a dedicated smart phone application, although one could be used, if desired.

FIG. 2 is a block diagram of a verification system that provides pseudo random strings to users at various locations and remotely receives the strings from the users, in order to verify that users are actually in the proximity of the respective display unit. FIG. 2 shows a web server 16 coupled to a network 18, which may be comprised of the internet, for example. The server 16 may be comprised of a computer having a processor, storage device, etc. The display unit 12, described above, generates the pseudo random string based on a predetermined predictable algorithm. The server 16 is programmed to be able to duplicate the pseudo random string, or to calculate the pseudo random string for any particular time. The server 16 is capable of work in conjunction with any number of display units.

FIG. 2 also shows a plurality of display units 12 and corresponding optional signs 10 in two different locations. When the server 16 receives messages from users, the server 16 will know which respective display unit 12 to which the message relates (due to the particular web address accessed by the user) as well as what string the display unit 12 should have been displaying when the user viewed it. FIG. 2 also shows a plurality of mobile devices, such as smart phones 20, which are used by users to transmit messages to the servers, including the value of the currently displayed pseudo random string. Each smart phone 20 includes a user interface 22 and an antenna 24. Other components of the smart phones 20 are not shown. When a user accesses the respective web address and is prompted to enter the value shown on the display unit 12, the user will use the user interface 22 (e.g., keypad, touch screen, voice recognition, OCR scanner, etc.) to enter the string. The string will then be transmitted via the network 18 to the server 16, where the information can be used for the respective rewards program or other verification system.

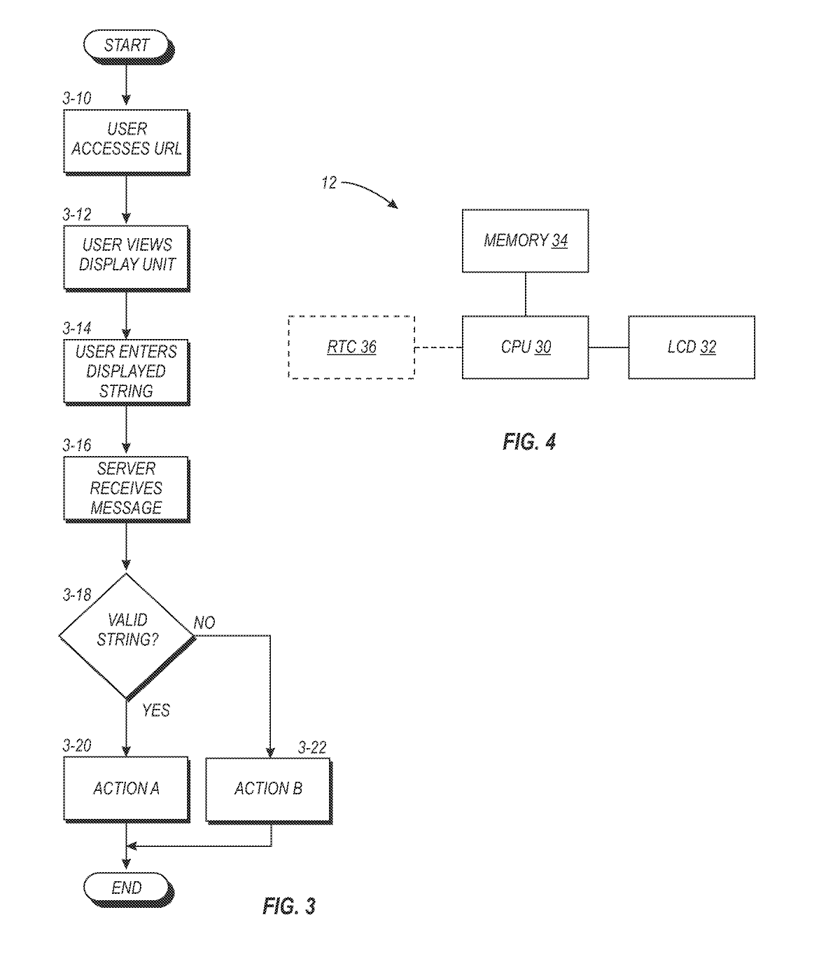

FIG. 3 is a flowchart illustrating the operation of the verification system shown in FIG. 2. This example will be described in the context of a single user visiting a location of a single display unit and going through a check in process. At step 3-10, the user initiates the process by entering a URL (via a keypad, bar code reader, NFC reader, OCR scanner, etc.) into the user's smart phone (or similar device). At step 3-12, the user views the display unit to read the pseudo random string. At step 3-14, the user enters the viewed pseudo random string, and the smart phone transmits a message to the server 16. Once the server 16 receives the message (step 3-16), the server determines whether the string entered by the user is valid (step 3-18) by comparing the received string with the string that should have been displayed at the respective display unit near the time that the message was sent and received. If the string is valid, a first action is taken (Action A in step 3-20). Action A may be to give the user credit in a rewards program for visiting a business. If the string is not valid, a second action is taken (Action B in step 3-22). Action B could be to track the message, but not give the user credit in the rewards program. Action B could also be to ignore the message completely. If a business owner desired, a user could be given credit for a number of wrong entries to account for periodic user or system error.

The display unit 12 shown in FIGS. 1 and 2 can be implemented in any desired manner. FIG. 4 is a block diagram illustrating one example of a display unit 12. In this example, the display unit 12 includes a processor 30, display 32 (LED, LCD, etc.), and memory 34 (volatile, non-volatile, etc.). The memory 34 could be internal to a microprocessor, external, or both. Other components (e.g., a power source, other circuit components), are not shown for clarity. FIG. 4 also shows an optional real time clock (RTC) circuit 36. The processor 30 includes program code for generating predictable pseudo random strings to be displayed on the display 32. In one example, memory 34 stores a table containing values for all of the pseudo random strings that will be displayed. In that example, the processor 30 reads the values of the strings, and displays the strings one after another. For example, assume that a new pseudo random string is displayed every minute. A table containing approximately 2 million pseudo random strings can be easily stored in the memory 34. The strings can be displayed one after another every minute for four years without the sequence repeating. In other examples, the processor 30 can use algorithms to generate predictable pseudo random strings.

In an example that uses the RTC 36, the processor can be programmed to display certain predictable pseudo random strings using an algorithm based on the time of day. Since the server also knows the time of day, the server can run the same algorithm and determine the same string for any given time. Different units can be seeded with different seed values, so different display units will display different strings at any given time.

In an example not using the RTC 36, the display unit can be programmed to start displaying pseudo random strings (e.g., using the strings stored in a table in memory 34) one after another upon power up. Using the processor's internal clock, the display unit can display each subsequent string after X clock cycles, where X equals the number of clock cycles per unit of time (e.g., per minute). By knowing when a display unit was powered up (for example, by logging the startup time in the factory), the server can determine which of the stored strings is being displayed at any given time. By not requiring a RTC and other circuitry, the display unit can be manufactured inexpensively, and can use very little power. For reasons discussed below, the accuracy of the internal processor clock may not be important, so the processor can be a low cost processor, and can be clocked at low clock rate, which will further reduce power consumption.

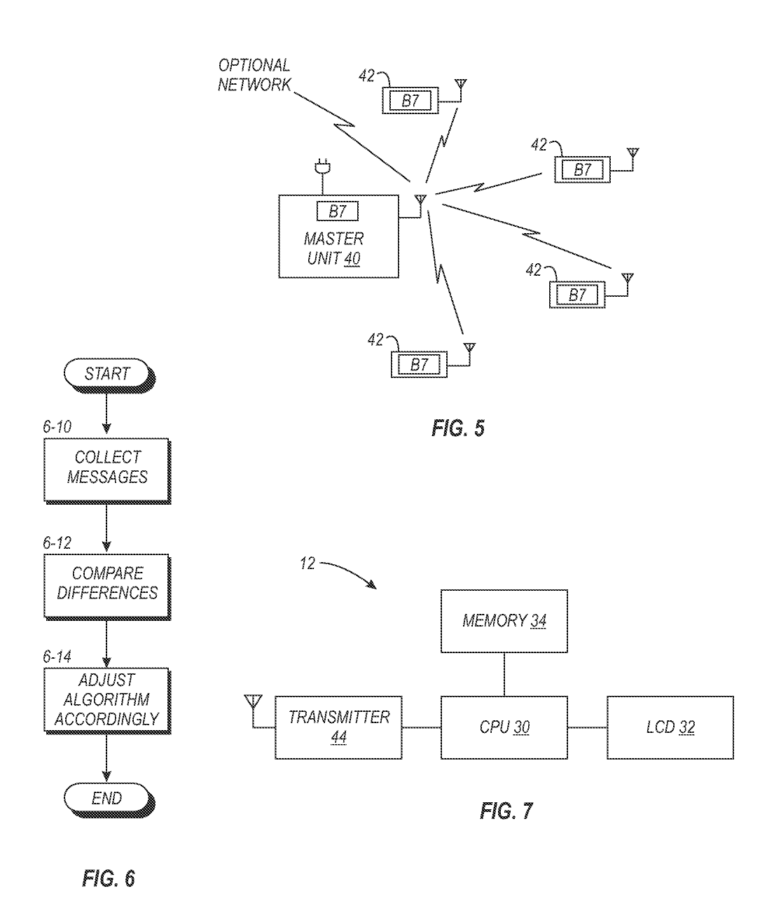

Some businesses may want multiple display units placed throughout a location. For example, a large retail store may want a display unit at each cash register, or distributed throughout the store. In one example, the business can simply use multiple displays, which are all associated with the business. So, even though each display will display a different string at any given time, whichever string a user enters, the server will know it comes from that business. FIG. 5 is a block diagram showing another example for providing multiple display units throughout a location using a master/follower arrangement.

FIG. 5 shows a master display unit 40 and a plurality of follower units 42. The master display unit 40 can be located at any desired location, as long as it is in wireless range of the follower units 42. In this example, the master display unit 40 includes the memory and processing power needed to generate the desired pseudo random strings. The master display unit 40 can be stand-alone (like the display units 12, described above), or may be networked to talk to the server, or other systems. Since the master display unit 40 can be located nearly anywhere, it can be powered by the mains, reducing the concern about power consumption. As the master display unit 40 generates pseudo random strings, the strings are transmitted to the plurality of follower units 42, where the strings are displayed. In one example, each follower unit 42 displays the same strings. In another example, the follower units 42 are addressable, and can display unique strings. The display unit 42 can be designed to be low power, since there is no need to transmit, just receive. Power consumption can be further reduced by only activating the radio receivers of the follower display units periodically. For example, the radio receiver could be placed in a low power state most of the time, and only periodically wake up to receive the next string. To further reduce power consumption, the display units 42 could be activated even less frequently to receive the next several stings. For example, the display unit radios could wake up every 10 minutes for a few seconds to receive the next 10 stings.

As mentioned above, in some examples, a display unit may not have an accurate RTC, or even with a RTC, may lose accuracy over time. Following is a description of techniques for correcting clock drift in the display units. Generally, the clock drift correction techniques leverage information provided by users to determine when a clock has drifted, and then adjusts the server's pseudo random string algorithms accordingly. Clock drift correction will be described in the context of the simple display unit 12 that displays a new string every minute.

During normal use of the verification system, the server will receive messages from multiple users throughout the business hours of the business. When the display unit clock is accurate, for a given minute (from 0 seconds to 60 seconds), the server will receive messages containing the string from that minute from about 10-70 seconds from the display change, depending on the speed of the user, network delays, etc. Over time, the server can monitor messages received and determine typical trends relating to the delay between a change in the pseudo random string and when the messages were sent. The server is programmed to realize that a correct string that is received a little late is still valid, perhaps because the user was distracted while entering the code, or the user's internet connection was slow. However, over time, the server can learn what a normal user delay is, and therefore when a delay is due to display unit clock drift. If correct strings are coming consistently later than normal, it can be assumed that the display unit clock is behind. Conversely, if correct strings are coming consistently earlier than normal, it can be assumed that the display unit clock is ahead. In either case, the clock drift can be addressed at the server, since it does not matter to the display unit what time it is.

FIG. 6 is a flow chart illustrating one example of display unit clock drift correction. In step 6-10, messages are collected by the server. This happens during the normal course of operation, as users enter pseudo random strings to check in. As messages are received, the server will know what code was entered, and the time that the message was sent (and/or received). The server can compare the time difference between the normal collection of stings (perhaps between 10 and 70 seconds from the display of a new string), with the actual collection of strings (step 6-12). For example, assume that on average, receiving strings 10-70 seconds from a display change is normal. Instead, if strings are consistently received at 30 and 90 seconds, the server can assume that the display unit clock has drifted about 20 seconds behind. Conversely, if strings are consistently received between 10 seconds before and 50 seconds after the display should have changed, the server can assume that the display unit clock has drifted about 20 seconds ahead. At step 6-14, the server adjusts its algorithm for the respective display unit accordingly. In other words, the server is able to map the clock drifts of any particular display unit, so clock drift is effectively fixed.

In another example, a display unit can include a transmitter for wirelessly transmitting the pseudo random string to users. For example, a display unit can generate the pseudo random string as described above, and then transmit the code over a relatively short range (e.g., using Bluetooth or another standard), where it can be received by a user's mobile device. FIG. 7 is a block diagram of one example of a display unit having a transmitter for transmitting pseudo random strings to users. FIG. 7 shows a display unit 12 having a processor 30, memory 34, and display 32, as before. The processor 30 is coupled to a transmitter 44 and antenna for wirelessly transmitting information to users. While this display unit will likely be more complex and consume more power than the display unit shown in FIG. 4, it may be more convenient to users. Also note that, with respect to FIG. 5, the master unit 40 could transmit pseudo random strings to the follower units 42 and directly to users over any desired protocol, such as Bluetooth.

Another advantage to the verification system described is that metrics can be tracked by the server. Detailed reports can be generated and provided to the business owner or third parties. The reports can be related to the number and frequency of repeat customers, times of day and days of the week that customers check in, etc. In the case of a business having multiple display units, reports can be provided showing which display unit were most commonly used.

In one example, each display unit (or group of units) will have one or more unique identifiers (e.g., serial number, activation code, etc.). When a business owner purchases a display unit, the business owner will log onto a web site and register the respective display unit with the system. Once registered, the server will be able to associate information received from users to the respective unit. From the identifier, the server will also be able to determine what pseudo random string the display unit will display at any particular time. In one example, a seed value is coded into the activation code so after registration, the server will know the seed value, and given the time of day, can predict the pseudo random string.

One unique aspect of the verification system described above is that the system can be packaged and sold in a retail box and be easily set up. As mentioned above, the verification does not require a computer/tablet/etc. or an internet connection to operate, so a purchaser can have the system up and running relatively quickly and painlessly. The system can be packaged in any manner desired, but in one example, a package can include one or more display units, one or more signs, and instructions for registering and using the system.

In some applications, a higher level of authentication may be desired. In that case, more levels of authentication can be used with the system described above. For example, users could try to game the system by viewing a pseudo random string and contacting a friend with the code, so the friend could also check in. In one example, a three factor authentication may be used using the overlay GPS/triangulation service from the “use your current location” function of a smart phone. In this example, the verification system would require that (1) the user check in, (2) that the user enter the pseudo random string, and that (3) the user's phone location (e.g., via GPS) be within a defined area.

As mentioned above, the verification system can be used for any desired application, in addition to things like rewards program. For example, the system can be used in any application where it is desired to verify that a person is actually at a particular location at a particular time. Examples include parents ensuring that their children are at a particular place, games, geocaching, military maneuvers, etc.

In the preceding detailed description, the disclosure is described with reference to specific exemplary embodiments thereof. Various modifications and changes may be made thereto without departing from the broader spirit and scope of the disclosure as set forth in the claims. The specification and drawings are, accordingly, to be regarded in an illustrative rather than a restrictive sense.

What is claimed is:

1. A method of location verification comprising:
providing an electronic device having a display and a processor;
displaying a pseudo random string on the electronic device, wherein the pseudo random string changes periodically;
receiving a message from a user at a first time period, the message including a string value;
calculating a pseudo random string that should have been displayed on the electronic device around the first time period;
comparing the string value included in the message from the user with the calculated pseudo random string; and
verifying the location of the user based on the comparison of the string value and the calculated pseudo random string.

2. The method of claim 1, wherein the electronic device includes a clock, the method further comprising monitoring messages received from a plurality of users to determine a trend relating to the delay between a change in the pseudo random string and when the messages were sent.

3. The method of claim 2, further comprising comparing previously determined trends with recently received messages.

4. The method of claim 3, determining whether the clock of the electronic device has drifted based on the comparison.

5. The method of claim 4, accounting for any determined clock drift when calculating the pseudo random string.

6. The method of claim 1, further comprising generating the pseudo random string based on the time of day and a seed value.

7. The method of claim 1, further comprising generating the pseudo random string based on clock cycles and a corresponding value stored in a memory.

8. The method of claim 1, wherein the string value included in the message from the user is entered into a mobile device by the user.

9. A location based verification system comprising:
an electronic device having a display and a processor, the processor including program code for displaying a sequence of pseudo random strings on the display;
a remote server having program code for calculating a pseudo random string that should be displayed on the electronic device at any particular time; and
program code for comparing a string value received from a user at a first time period with a calculated pseudo random string, wherein the calculated pseudo random string is calculated based on the first time period.

10. The location based verification system of claim 9, wherein the electronic device includes a memory, and wherein a plurality of pseudo random strings are stored in the memory.

11. The location based verification system of claim 10, wherein the program code for displaying a sequence of pseudo random strings on the display causes the plurality of pseudo random strings to be displayed on the display one at a time.

12. The location based verification system of claim 9, wherein the sequence of pseudo random strings are calculated based on the time of day and a seed value.

13. The location based verification system of claim 9, wherein the electronic device includes a clock, and wherein the location based verification system further comprises computer code for compensating for clock drift.

14. The location based verification system of claim 13, wherein the computer code for compensating for clock drift determines clock drift based on the times when string values are received from users.

15. The location based verification system of claim 13, further comprising a master device having a wireless transmitter, wherein the master device transmits pseudo random strings to the electronic device.

16. The location based verification system of claim 15, further comprising a plurality of electronic devices each having a display and a processor, wherein each of the plurality of electronic devices receives pseudo random strings from the master device.

17. A method of managing a customer rewards program comprising:
providing an electronic device having a display at a first location;
displaying a pseudo random string on the electronic device, wherein the pseudo random string changes periodically;
when a customer is in the proximity of the first location, receiving one or more messages from the customer, wherein the messages are sent by the customer using a mobile device, and wherein the message(s) include a customer identifier and a string value entered by the customer;
comparing the received string value entered by the customer with a calculation of what value the display should have been displaying at a time near when the message containing the string value was sent;
verifying the location of the customer based on the comparison of the received string value and the calculated value; and
awarding credits to the customer's rewards account if the customer's location was verified.
